(19) United States
(12) Patent Application Publication
(10) Pub. No.: US 2026/0171594 A1
(43) Pub. Date: Jun. 18, 2026

(54) BATTERY PACK

(71) Applicant: FORD GLOBAL TECHNOLOGIES, LLC, Dearborn, MI (US)

(72) Inventors: Reeves LI, Nanjing (CN); Kevin CHENG, Nanjing (CN); Tao SHEN, Nanjing (CN); Bin YIN, Nanjing (CN)

(21) Appl. No.: 19/415,910

(22) Filed: Dec. 11, 2025

(30) Foreign Application Priority Data
Dec. 12, 2024 (CN) 202411836022.1

(51) Int. Cl. H01M 50/342; B60L 50/64; H01M 10/625; H01M 10/658; H01M 50/204; H01M 50/249; H01M 50/289

(52) U.S. Cl. CPC H01M 50/3425; H01M 10/625; H01M 10/658; H01M 50/204; H01M 50/249; H01M 50/289; B60L 50/64; H01M 2220/20

(57) ABSTRACT

A battery pack may include a first compartment accommodating a battery unit. The first compartment includes a first side wall having a first opening, a first flexible thermal insulation layer covering the first opening and having a first weakened structure opposite to the first opening, and a second flexible thermal insulation layer connected to the first flexible thermal insulation layer and aligned with the first opening. The first flexible thermal insulation layer is located between the second flexible thermal insulation layer and the first side wall. The proposed battery pack can provide adaptive isolation measures for battery units under different working conditions, while allowing the discharging of gas, and can at least to some extent reduce the ability of the exhaust gas from the battery unit from influencing other battery units inside the battery pack.

### CROSS-REFERENCE TO RELATED APPLICATIONS

This disclosure claims priority to Chinese Patent Application No. 202411836022.1, which was filed on Dec. 12, 2024 and is incorporated herein by reference in its entirety.

### TECHNICAL FIELD

This disclosure generally relates to a battery pack.

### BACKGROUND

With technological development, the demand for electrical power in various electrical devices continues to increase. For example, for vehicles, increased driving range requirements, increased types and quantities of in-vehicle equipment, etc., all lead to an increase in the overall power demand of the vehicle, which makes the battery pack used to provide power larger in size and more complex internal structures. The interior of a battery pack typically contains many battery units, which may generate gas under certain conditions. To address the issue of gas emission, various technical solutions have been proposed.

For example, patent document US20240283084A1 discloses a battery device, which includes: a battery unit stack formed by stacking multiple battery units; and a housing, with the battery unit stack accommodated inside the housing. In the housing, multiple first exhaust ports may be formed in an upper plate covering an upper surface of the battery unit stack, and multiple second exhaust ports may be formed in a side plate covering a first side surface of the battery unit stack.

Inventors of the present disclosure recognize that such conventional solutions in the prior art still leave room for advancements with respect to reducing the mutual influence of gas emission between battery units to at least some extent.

### SUMMARY

The present disclosure summarizes aspects of the embodiments and should not be used to limit the claims. Other implementations are contemplated in accordance with the techniques described herein, as will be apparent to those skilled in the art upon examination of the following drawings and detailed description, and such implementations are intended to be within the scope of this application.

The inventors of the present application have recognized the need for a battery pack, which can provide adaptive isolation measures for battery units under different working conditions, while allowing the discharging of gas, and can at least to some extent reduce the influence of the exhaust gas from the battery unit on other battery units inside the battery pack, thereby increasing user satisfaction.

An aspect of the present disclosure provides a battery pack, comprising a first compartment accommodating a battery unit, the first compartment comprising: a first side wall having a first opening; a first flexible thermal insulation layer covering the first opening, wherein the first flexible thermal insulation layer has a first weakened structure opposite to the first opening; and a second flexible thermal insulation layer connected to the first flexible thermal insulation layer and aligned with the first opening; wherein the first flexible thermal insulation layer is located between the second flexible thermal insulation layer and the first side wall.

According to an embodiment of the present disclosure, the battery pack further comprises a second compartment, the second compartment comprising: a second side wall having a second opening; a third flexible thermal insulation layer covering the second opening, wherein the third flexible thermal insulation layer has a second weakened structure opposite to the second opening; and a fourth flexible thermal insulation layer connected to the third flexible thermal insulation layer and aligned with the second opening, wherein the third flexible thermal insulation layer is located between the fourth flexible thermal insulation layer and the second side wall; and wherein the first side wall is arranged opposite to the second side wall, and an exhaust channel is formed between the first side wall and the second side wall.

According to an embodiment of the present disclosure, the battery pack further comprises an exhaust valve, wherein the exhaust channel is in fluid communication with the exhaust valve.

According to an embodiment of the present disclosure, the battery pack further comprises a third compartment adjacent to the first compartment, and a fourth compartment adjacent to the second compartment, wherein a first thermal insulation plate is located between the first compartment and the third compartment, and a second thermal insulation plate is located between the second compartment and the fourth compartment.

According to an embodiment of the present disclosure, the first side wall comprises a second weakened structure.

According to an embodiment of the present disclosure, the first weakened structure is configured to rupture when an internal pressure of the first compartment exceeds an external pressure by a first threshold, the second weakened structure is configured to rupture when the internal pressure of the first compartment exceeds the external pressure by a second threshold, and the second threshold is greater than the first threshold.

According to an embodiment of the present disclosure, the second weakened structure comprises a discontinuous cut seam or groove provided in the first side wall, and the cut seam or groove defines at least a portion of a boundary of the first side wall.

According to an embodiment of the present disclosure, the battery unit in the first compartment has an exhaust port facing the first side wall.

According to an embodiment of the present disclosure, the first side wall comprises a thermal isolation material.

According to an embodiment of the present disclosure, the first flexible thermal insulation layer has a first thickness, and the second flexible thermal insulation layer has a second thickness greater than the first thickness.

Another aspect of the present disclosure provides a battery pack, comprising a first compartment accommodating a battery unit, the first compartment comprising: a first side wall; and a first element disposed on the first side wall, wherein the first element has a first state in which the first element opens when an internal pressure of the first compartment exceeds an external pressure by a first threshold, and a second state in which the first element remains closed until the external pressure exceeds the internal pressure by a second threshold, and the first threshold is less than the second threshold.

According to an embodiment of the present disclosure, the battery pack further comprises a second compartment accommodating a battery unit, the second compartment comprising: a second side wall; and a second element disposed on the second side wall, wherein the second element has a first state in which the second element opens when an internal pressure of the second compartment exceeds an external pressure by a third threshold, and a second state in which the second element remains closed until the external pressure exceeds the internal pressure by a fourth threshold, and the third threshold is less than the fourth threshold; and wherein the first side wall is arranged opposite to the second side wall, an exhaust channel is formed between the first side wall and the second side wall, and the exhaust channel is in fluid communication with an exhaust valve.

According to an embodiment of the present disclosure, the first side wall is provided with a first opening, the first element comprises a first thermal insulation layer covering the first opening from an exterior of the first compartment, and the first thermal insulation layer is connected to the first side wall at a position vertically above the first opening.

According to an embodiment of the present disclosure, the first thermal insulation layer comprises a flexible thermal isolation material.

According to an embodiment of the present disclosure, the battery pack further comprises a third compartment adjacent to the first compartment, wherein the first element of the first compartment and a third element of the third compartment are integrally formed, a cut is provided between the first element and the third element, and the cut extends vertically upward from a lower edge for at least a portion of a longitudinal height.

According to an embodiment of the present disclosure, the first side wall is provided with a first opening; and the first element comprises a first flexible thermal insulation layer covering the first opening, and a second flexible thermal insulation layer connected to the first flexible thermal insulation layer and aligned with the first opening, the first flexible thermal insulation layer is located between the second flexible thermal insulation layer and the first side wall, and a bonding strength between the first flexible thermal insulation layer and the first side wall is lower than a bonding strength between the first flexible thermal insulation layer and the second flexible thermal insulation layer.

According to an embodiment of the present disclosure, the first element comprises a groove that does not penetrate through the first side wall, and the groove is provided on an inner side of the first side wall.

According to an embodiment of the present disclosure, the first side wall has a first opening, and the first element comprises: a first flexible thermal insulation layer covering the first opening, wherein the first flexible thermal insulation layer has a first weakened structure opposite to the first opening; and a second flexible thermal insulation layer connected to the first flexible thermal insulation layer and aligned with the first opening; and wherein the first flexible thermal insulation layer is located between the second flexible thermal insulation layer and the side wall.

Yet another aspect of the present disclosure provides a battery pack, comprising a first battery array, the first battery array comprising a first compartment and a third compartment that respectively accommodate several battery cells and are adjacent to each other, wherein the first compartment and the third compartment comprise: a first side wall extending from the first compartment to the third compartment; and a first element and a third element disposed on the first side wall, wherein the first element and the third element correspond to the first compartment and the third compartment, respectively, and each has a first state in which it opens when an internal pressure of the first compartment or the third compartment exceeds an external pressure by a first threshold, and a second state in which it remains closed until the external pressure exceeds the internal pressure by a second threshold, and the first threshold is less than the second threshold.

According to an embodiment of the present disclosure, the battery pack further comprises a second battery array, and the second battery array comprises a second compartment and a fourth compartment that respectively accommodate several battery cells and are adjacent to each other, wherein the second compartment and the fourth compartment comprise: a second side wall extending from the second compartment to the fourth compartment; and a second element and a fourth element disposed on the second side wall, wherein the second element and the fourth element correspond to the second compartment and the fourth compartment, respectively, and each has a first state in which it opens when an internal pressure of the second compartment or the fourth compartment exceeds an external pressure by a third threshold, and a second state in which it remains closed until the external pressure exceeds the internal pressure by a fourth threshold, and the third threshold is less than the fourth threshold; and wherein the first side wall is arranged opposite to the second side wall, an exhaust channel is formed between the first side wall and the second side wall, and the exhaust channel is in fluid communication with an exhaust valve.

### BRIEF DESCRIPTION OF THE FIGURES

In order to better understand the present disclosure, reference can be made to the embodiments shown in the following drawings. The components in the drawings may not necessarily be drawn to scale, and relevant components may be omitted, or in some cases, the scale may have been enlarged to emphasize and clearly illustrate the novel features described in this disclosure. Additionally, as known in the art, system components can be arranged differently. Further in the figures, like reference numbers refer to like parts throughout the different figures.

FIG. 1 illustrates a schematic diagram of a vehicle comprising a battery pack according to one or more embodiments of the present disclosure;

FIG. 2 illustrates a top view of a battery pack according to one or more embodiments of the present disclosure;

FIG. 3 illustrates a top schematic view of an internal layout of a battery pack according to one or more embodiments of the present disclosure;

FIG. 4 illustrates a side schematic view of a first compartment of a battery pack according to one or more embodiments of the present disclosure;

FIG. 5 illustrates a longitudinal cross-sectional schematic view of a first compartment of a battery pack according to one or more embodiments of the present disclosure;

FIG. 6 illustrates a schematic view of an inner side of a first side wall of a first compartment of a battery pack according to one or more embodiments of the present disclosure;

FIG. 7 illustrates a schematic view of an outer side of a first side wall of a first compartment of a battery pack according to one or more embodiments of the present disclosure;

FIG. 8 illustrates a longitudinal cross-sectional schematic view of a second compartment of a battery pack according to one or more embodiments of the present disclosure;

FIG. 9 illustrates a schematic view of an inner side of a second side wall of a second compartment of a battery pack according to one or more embodiments of the present disclosure;

FIG. 10 illustrates a top schematic view of an internal layout of a battery pack according to one or more other embodiments of the present disclosure;

FIG. 11 illustrates a longitudinal cross-sectional schematic view of a first compartment of a battery pack according to one or more other embodiments of the present disclosure;

FIG. 12a illustrates a schematic view of a battery pack in a second state according to one or more other embodiments of the present disclosure;

FIG. 12b illustrates a schematic view of a battery pack in a first state according to one or more other embodiments of the present disclosure;

FIG. 13 illustrates a schematic view of an outer side of a first side wall of a first compartment of a battery pack according to one or more other embodiments of the present disclosure;

FIG. 14 illustrates a longitudinal cross-sectional schematic view of a first compartment of a battery pack according to yet one or more other embodiments of the present disclosure;

FIG. 15 illustrates a schematic view of a first side wall of a first compartment of a battery pack according to still one or more other embodiments of the present disclosure;

FIG. 16 illustrates a side cross-sectional view of a first side wall of a first compartment of a battery pack according to still one or more other embodiments of the present disclosure;

FIG. 17 illustrates a longitudinal cross-sectional schematic view of a first compartment of a battery pack according to a further one or more other embodiments of the present disclosure;

FIG. 18 illustrates a schematic view of an inner side of a first side wall of a first compartment of a battery pack according to a further one or more other embodiments of the present disclosure; and

FIG. 19 illustrates a top schematic view of an internal layout of a battery pack according to a still further one or more other embodiments of the present disclosure.

### DETAILED DESCRIPTION

Embodiments of the present disclosure are described below. However, it is to be understood that the disclosed embodiments are merely examples and other embodiments may take various and alternative forms. The figures are not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure. As will be understood by those of ordinary skill in the art, various features shown and described with reference to any one figure may be combined with features shown in one or more other figures to produce embodiments not expressly shown or described. The combinations of features shown herein provide representative embodiments for typical applications. However, various combinations and modifications of the features consistent with the teachings of the present disclosure may be desired for certain particular applications or implementations.

In this application document, when an element or part is referred to as being “on . . . ”, “bonded to”, “connected to”, or “coupled to” another element or part, the element or part can be directly on another element or part, can be bonded, connected or coupled to another element or part, or there may be intervening elements or parts. In contrast, when an element is referred to as being “directly on . . . ”, “directly bonded to”, “directly connected to”, or “directly coupled to” another element or part, the intervening elements or parts may not be present. Other words used to describe the relationship between elements should be interpreted in a like fashion.

As mentioned in the background, the inventors of the present disclosure have recognized that there is room for advancements in the technical solutions of the battery pack in the prior art with respect to reducing the mutual influence of gas emission between battery units. There is a need for a battery pack that, for the battery unit under different working conditions, can provide adaptive isolation measures to allow the discharging of gas while at least reducing the influence of the exhaust gas from the battery unit on other battery units within the battery pack. Based on these issues and the room for advancements in the prior art, the inventors of the present application have provided, in one or more embodiments, a battery pack believed to address one or more of the deficiencies in the prior art.

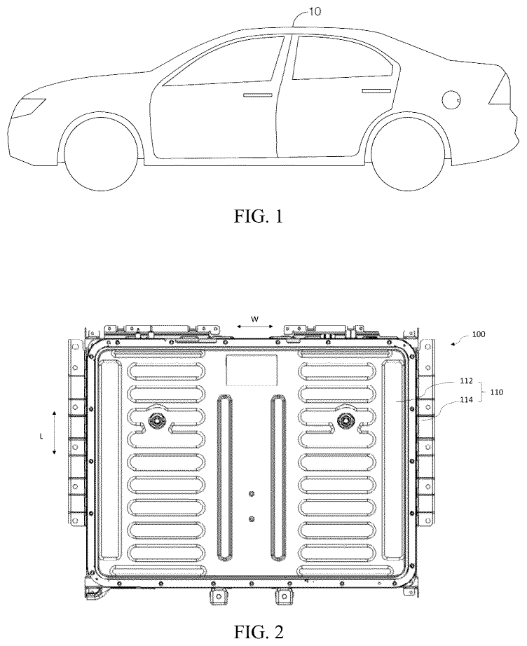

Firstly, FIG. 1 illustrates a schematic diagram of a vehicle 10 that can use a battery pack according to one or more embodiments of the present disclosure. It should be understood that in the context of the present disclosure, the vehicle 10 implementing the present disclosure may refer to any vehicle containing a battery pack, such as comprising, but not limited to fossil fuel vehicles, electric vehicles (such as plug-in hybrid electric vehicles (PHEVs), fully hybrid electric vehicles (FHEVs), mild hybrid electric vehicles (MHEVs), or battery electric vehicles (BEVs)), or even ships, aircraft, etc. The vehicle 10 may include components related to mobility, such as an engine, an electric motor, a transmission, a suspension, a drive shaft, and/or wheels, and the like. The vehicle 10 may be non-autonomous, semi-autonomous (e.g., some conventional movement functions autonomously controlled by the vehicle) or autonomous (e.g., motion functions autonomously controlled by the vehicle without direct input from the user).

FIG. 2 is a top view of a battery pack 100 according to one or more embodiments of the present disclosure. As shown in the figure, the battery pack 100 includes a housing 110 composed of an upper cover plate 112 and a lower tray 114, and a plurality of reinforcing structures and connection positions can be provided around the housing 110, which are omitted here and will not be marked and described one by one for brevity. The battery pack 100 is generally in fluid communication with the external atmosphere via an exhaust valve.

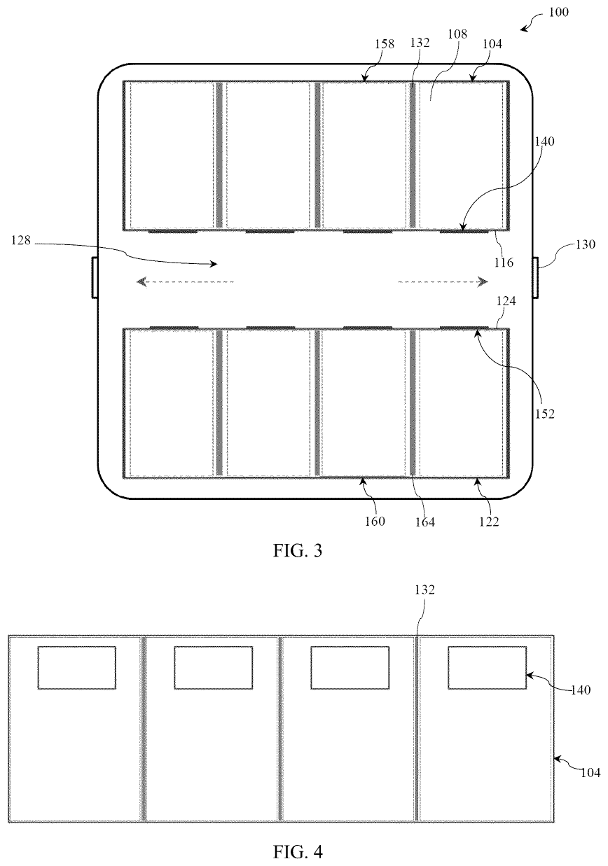

The battery pack 100 according to one aspect of the present disclosure is generally described below with reference to FIGS. 3 to 9.

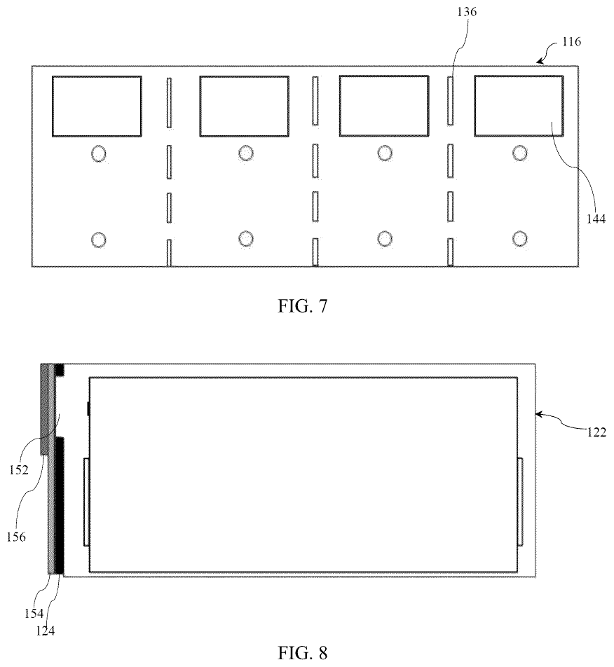

The battery pack 100 comprises a first compartment 104, which can accommodate a battery unit 108. It may be understood that the number of the battery unit 108 within the first compartment 104 may differ from that illustrated in the figure, such as being fewer or greater, depending on the structure and type of the battery pack. The battery unit 108 may be understood to encompass a battery cell, an array composed of a plurality of battery units, or a battery module, among others. The first compartment 104 further comprises a first side wall 116, a first flexible thermal insulation layer 142, and a second flexible thermal insulation layer 144. The first side wall 116 defines at least a portion of the space of the first compartment 104. The first side wall 116 is provided with a first opening 140. As further described below with reference to FIG. 3, in some embodiments, gas discharged from the battery unit 108, for example, may pass through the first opening 140. The first flexible thermal insulation layer 142 covers the first opening 140 and is provided with a first weakened structure 146. The first weakened structure 146 may be, for example but not limited to, a score extending only partially through the depth of the first flexible thermal insulation layer 142, such as the X-shaped score illustrated in FIG. 6. In other embodiments of the battery pack 100, the score may completely penetrate the first flexible thermal insulation layer 142 or may adopt other different shapes. Alternatively, the first weakened structure 146 may be implemented without a score, but rather by employing a different material or a variation in thickness locally. The first weakened structure 146 is opposite to the first opening 140, such that the first weakened structure 146 is exposed to the internal space of the first compartment 104 via the first opening 140, and is visible on the inner side surface of the first side wall 116 as shown in FIG. 6. The second flexible thermal insulation layer 144 is connected to the first flexible thermal insulation layer 142 and is aligned with the first opening 140, with the outer side surface of the first side wall 116 being shown in FIG. 7. The first flexible thermal insulation layer 142 is disposed between the second flexible thermal insulation layer 144 and the first side wall 116. The connection between the first flexible thermal insulation layer 142, the second flexible thermal insulation layer 144, and the first side wall 116 may be achieved via, but not limited to, one or more of adhering, welding, hot pressing, and other suitable processes.

In the present embodiment, the second flexible thermal insulation layer 144 is aligned with the first opening 140, such that its projection toward the plane of the first side wall 116 corresponds to the area of the first opening 140. In one embodiment, the projection may cover and extend beyond the area of the first opening 140. In another embodiment, the projection may completely coincide with the area of the first opening 140. In yet another embodiment, the projection may cover only a portion of the area of the first opening 140. An intermediate element may or may not be present between the second flexible thermal insulation layer 144 and the first side wall 116. Furthermore, in this embodiment, “inner side” and “outer side” may refer to positions relative to the mentioned enclosed space. For the side wall of a compartment, the surface facing the interior of the compartment may be referred to as the “inner side,” while the surface facing the exterior of the compartment may be referred to as the “outer side.”

In the embodiment of the battery pack 100, the first weakened structure 146 is provided on the portion of the first flexible thermal insulation layer 142 corresponding to the first opening 140. Consequently, when the battery unit 108 within the first compartment 104 discharges gas and the internal pressure exceeds the external pressure by a predetermined internal pressure threshold, the first weakened structure 146 ruptures. This rupture focusses stress on a small portion (such as a seam) of the outer second flexible thermal insulation layer 144 adjacent to the rupture, thereby further tearing the second flexible thermal insulation layer 144 and allowing gas within the first compartment 104 to be discharged therethrough. Furthermore, the second flexible thermal insulation layer 144 is connected to the outer side of the first flexible thermal insulation layer 142 at a position aligned with the first opening 140, which provides a certain degree of reinforcement to the first opening 140 and the first weakened structure 146 from the outside. This reinforcement prevents an equivalent pressure increase outside the first compartment 104 from breaching the second flexible thermal insulation layer 144 and the first flexible thermal insulation layer 142, maintaining the first compartment 104 closed at least until the external pressure exceeds the internal pressure by an external pressure threshold. This external pressure threshold can be significantly greater than the internal pressure threshold. This solution allows the gas inside the first compartment 104 to be discharged as needed, while also reducing, to some extent, the influence of pressure increases caused by other parts in the battery pack 100 on the interior of the first compartment 104.

According to one or more embodiments of the present disclosure, the configuration of the aforementioned internal pressure threshold and external pressure threshold can be achieved by using different thicknesses of the first flexible thermal insulation layer 142 and the second flexible thermal insulation layer 144, different areas of the first opening 140, and/or different configurations of the first weakened structure 146. In one embodiment, the first flexible thermal insulation layer 142 has a first thickness, for example, 0.1 mm to 0.2 mm, and the second flexible thermal insulation layer 144 has a second thickness greater than the first thickness, for example, 0.5 mm to 1 mm. The above values are merely examples and not limiting. A thicker second flexible thermal insulation layer 144 can provide greater resistance against external pressure, while a thinner first flexible thermal insulation layer 142 allows the internal pressure to cause rupture more easily, thereby creating a greater difference between the corresponding internal pressure threshold and external pressure threshold.

According to one or more embodiments of the present disclosure, the first flexible thermal insulation layer 142 and the second flexible thermal insulation layer 144 can include any material capable of providing certain thermal insulation and having a degree of toughness, such as mica, ceramic, silicone, and other materials. For example, the first flexible thermal insulation layer 142 can be mica paper, and the second flexible thermal insulation layer 144 can be mica tape. In some embodiments of the battery pack 100, the first side wall 116 can also include a thermal isolation material, for example, containing mica, ceramic, silicone, and other materials, to provide better isolation from heat outside the first compartment 104.

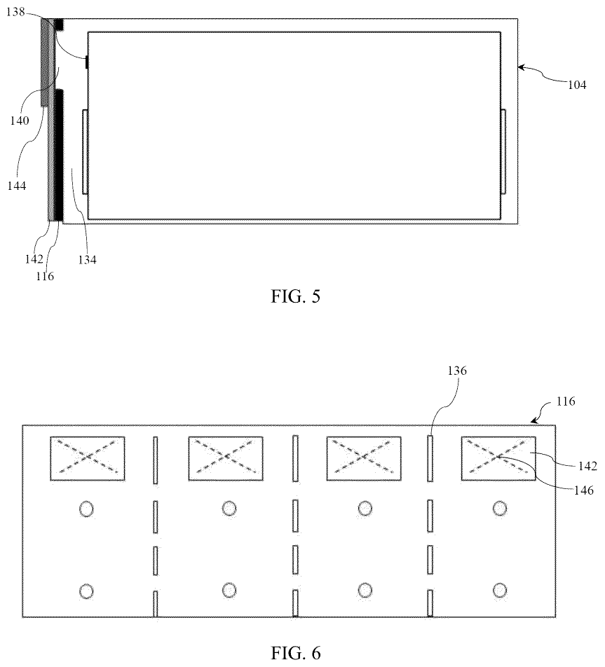

Referring to FIG. 5, in one embodiment, an exhaust port 138 of the battery unit 108 in the first compartment 104 can face the first side wall 116. This structural arrangement allows the gas to exit the first compartment 104 via the first opening 140 through the shortest possible path when the battery unit 108 discharges gas. As shown in the figure, a gap 134 can be provided between the battery unit 108 and the first side wall 116, which can prevent blocking the gas flow to the exhaust port 138 and provide space for structures such as the electrical connection between corresponding tabs.

According to one or more embodiments of the present disclosure, the first side wall 116 can further include a second weakened structure 136, as shown in FIGS. 6 and 7. The second weakened structure 136 can be, for example, a discontinuous cut seam or groove that penetrates or partially penetrates the first side wall 116. The second weakened structure 136 can provide a customizable multi-stage opening strategy for the first compartment 104. In one embodiment, the first weakened structure 146 can be configured to rupture when the internal pressure of the first compartment 104 exceeds the external pressure by a first internal pressure threshold, and the second weakened structure 136 can be configured to rupture when the internal pressure of the first compartment 104 exceeds the external pressure by a second internal pressure threshold, wherein the second internal pressure threshold is greater than the first internal pressure threshold. This allows the first side wall 116 to provide corresponding varying degrees of opening when the pressure increase inside the first compartment 104 reaches different levels, thereby discharging gas at different rates. In one embodiment and with reference to FIGS. 6 to 7, the cut seam or groove of the second weakened structure 136 can form at least a portion of the boundary of the first side wall 116, thereby providing a larger gas exhaust port and achieving a higher exhaust rate in the event of its rupture.

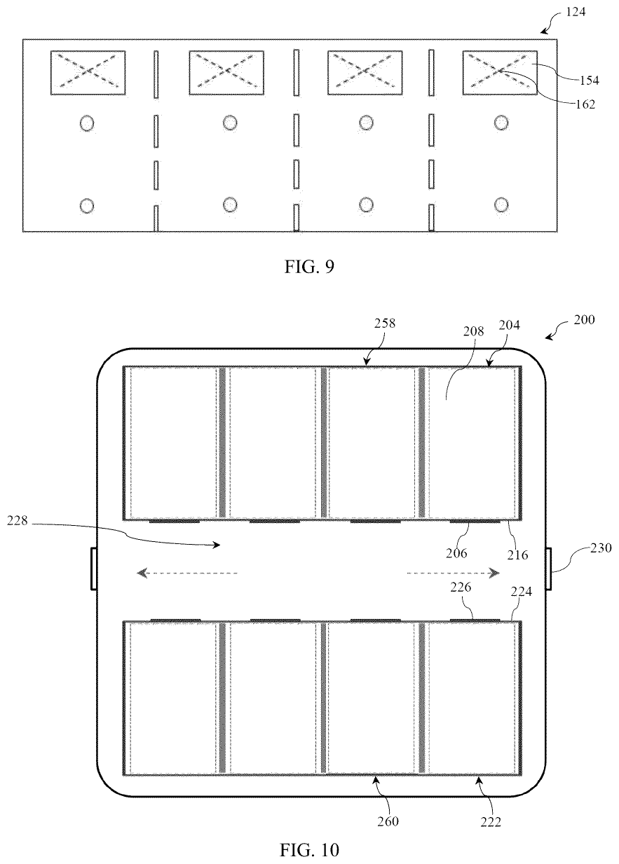

As shown in FIGS. 3 and 8, the battery pack 100 can further include a second compartment 122. The second compartment 122 includes a second side wall 124, a third flexible thermal insulation layer 154, and a fourth flexible thermal insulation layer 156. The second side wall 124 is provided with a second opening 152, and the third flexible thermal insulation layer 154 covers the second opening 152. A second weakened structure 162 is provided on the third flexible thermal insulation layer 154 and is opposite to the second opening 152. FIG. 9 schematically shows the inner surface of the second side wall 124. The fourth flexible thermal insulation layer 156 is connected to the third flexible thermal insulation layer 154 and is aligned with the second opening 152. The third flexible thermal insulation layer 154 is located between the fourth flexible thermal insulation layer 156 and the second side wall 124. The first side wall 116 of the first compartment 104 and the second side wall 124 of the second compartment 122 are arranged opposite to each other, and an exhaust channel 128 is formed between them. In this arrangement, the first compartment 104 and the second compartment 122 are positioned opposite to each other and share the exhaust channel 128. This achieves a compact overall structure, while through their respective flexible thermal insulation layers and weakened structure configurations, it allows gas within the corresponding compartment to be discharged as needed, and to some extent, reduces the influence of pressure increase outside the compartment caused by the exhaust gas from one compartment on the non-exhaust compartment on the opposite side.

The battery pack 100 may further include an exhaust valve 130. As shown in FIG. 3, the exhaust channel 128 is in fluid communication with the exhaust valve 130. This allows gas discharged from some open compartments within the battery pack to flow through the exhaust channel 128 to the exhaust valve 130 and be discharged there from the battery pack 100, thereby reducing the internal pressure of the battery pack 100. It should be understood that the position, shape, and configuration of the exhaust valve 130 in FIG. 3 are merely exemplary. Depending on the actual structure and application of the battery pack, the exhaust valve 130 can be arranged at different positions such as the top, bottom, or side of the battery pack, and may have different shapes or configurations.

The battery pack 100 may further include a third compartment 158 and a fourth compartment 160. Referring to FIG. 3, the third compartment 158 is adjacent to the first compartment 104, and the fourth compartment 160 is adjacent to the second compartment 122. The third compartment 158 and the fourth compartment 160 can also have the same or similar structure as the first compartment 104 and the second compartment 122, such as openings, flexible protective layers, etc. A first thermal insulation plate 132 is located between the first compartment 104 and the third compartment 158, and a second thermal insulation plate 164 is located between the second compartment 122 and the fourth compartment 160. Providing thermal insulation plates between adjacent compartments can slow down heat transfer between them and isolate mutual influence.

Referring to FIGS. 10 to 13, a battery pack 200 according to another embodiment of the present disclosure is schematically shown. For brevity, only some features of the battery pack 200 are described below. Where compatible, other features can be referenced from the foregoing description regarding the battery pack 100. The battery pack 200 includes a first compartment 204 accommodating a battery unit 208. The first compartment 204 further includes a first side wall 216 and a first element 206 disposed on the first side wall 216. The first element 206 has a first state and a second state. In the first state, the first element 206 opens when the internal pressure of the first compartment 204 exceeds the external pressure by a first internal pressure threshold; and in the second state, the first element 206 remains closed until the external pressure exceeds the internal pressure by a second external pressure threshold, wherein the first internal pressure threshold is less than the second external pressure threshold. For example, the first internal pressure threshold can be 0.5-3 kPa, and the second external pressure threshold can be 5-10 kPa. The above values are merely examples and not limiting. As described in detail elsewhere in this description, the first element 206 can adopt different structures according to different battery structures and gas discharge requirements. Thus, it allows the gas inside the first compartment 204 to be discharged as needed, while also reducing, to some extent, the influence of pressure increases caused by other parts in the battery pack 200 on the battery unit 208 inside the first compartment 204.

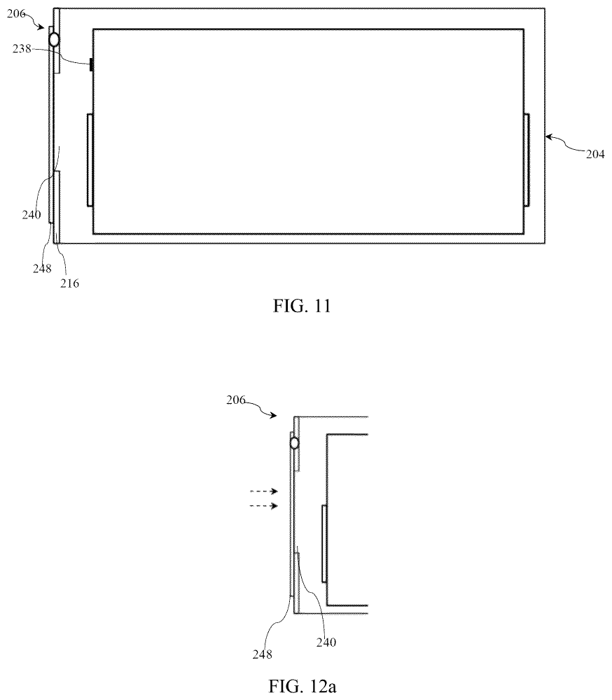

Referring to FIG. 11, a first opening 240 can be provided in the first side wall 216 of the battery pack 200. The first element 206 can include a first thermal insulation layer 248 covering the first opening 240 from an exterior of the first compartment 204. The first thermal insulation layer 248 is connected to the first side wall 216 at a position vertically above the first opening 240. Further referring to FIGS. 12a and 12b, FIG. 12b shows the first state of the first element 206, where the internal pressure of the first compartment 204 exceeds the external pressure by the first internal pressure threshold. The gas inside the first compartment 204 pushes the first thermal insulation layer 248 outward, and the first thermal insulation layer 248 pivots outward about its upper fixed point, allowing the gas inside the first compartment 204 to be discharged into other spaces within the battery pack 200. FIG. 12a shows the second state of the first element 206, where the external pressure outside the first compartment 204 exceeds the internal pressure but has not yet reached the second external pressure threshold. The first thermal insulation layer 248 is pressed against the first side wall 216 by the external pressure, keeping the first compartment 204 in a closed state, thereby preventing or reducing the influence of the pressure increases caused by other parts in the battery pack 200 on the interior of the first compartment 204.

According to one or more embodiments of the present disclosure, the first thermal insulation layer 248 may comprise a flexible thermal isolation material, such as but not limited to a fiber insulation blanket containing materials such as mica, ceramic, silicone, etc. This can allow the first thermal insulation layer 248 to pivot outward about its upper fixed point and deflect outward in the first state, further opening the passage for gas, as shown in FIG. 12b, and can enable the first thermal insulation layer 248 to better seal the internal space of the first compartment 204 when pressed against the first side wall 216 by the external pressure in the second state.

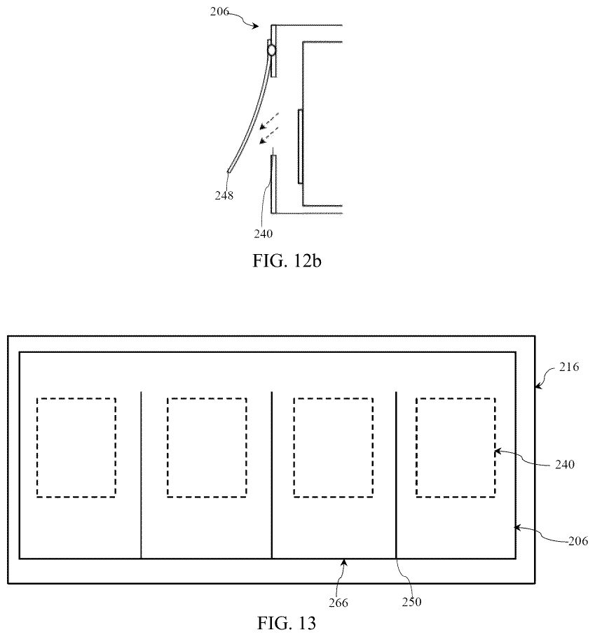

The battery pack 200 may further include a third compartment 258, referring to FIGS. 10 and 13. The third compartment 258 is adjacent to the first compartment 204 and has a third element 266 similar to the first element 206. The first element 206 of the first compartment 204 and the third element 266 of the third compartment 258 may be integrally formed, for example, as a single piece of fiber insulation blanket. A cut 250 may be provided between the first element 206 and the third element 266, extending vertically upward from its lower edge for at least a portion of the longitudinal height. The cut 250 may, for example, extend upward to a height above the upper edge of the first opening 240, thereby simplifying the structure of the first element 206 and the third element 266 and the corresponding manufacturing and assembly.

The battery pack 200 may further include a second compartment 222 accommodating a battery unit 208, as shown in FIG. 10. The second compartment 222 includes a second side wall 224 and a second element 226 disposed on the second side wall 224. The second element 226 has a first state in which it opens when the internal pressure of the second compartment 222 exceeds the external pressure by a third internal pressure threshold, and a second state in which it remains closed until the external pressure exceeds the internal pressure by a fourth external pressure threshold, wherein the third internal pressure threshold is less than the fourth external pressure threshold. The first side wall 216 and the second side wall 224 are arranged opposite to each other, and an exhaust channel 228 is formed between them. The exhaust channel 228 is in fluid communication with an exhaust valve 230. In this arrangement, the first compartment 204 and the second compartment 222 are positioned opposite to each other and share the exhaust channel 228. This achieves a compact overall structure, while through their respective first element 206 and second element 226, it allows gas within the corresponding compartment to be discharged as needed, and to some extent, reduces the influence of pressure increase outside the compartment caused by the exhaust gas from the compartment on the opposite side. Furthermore, the second compartment 222 may further have a fourth compartment 260 adjacent to it.

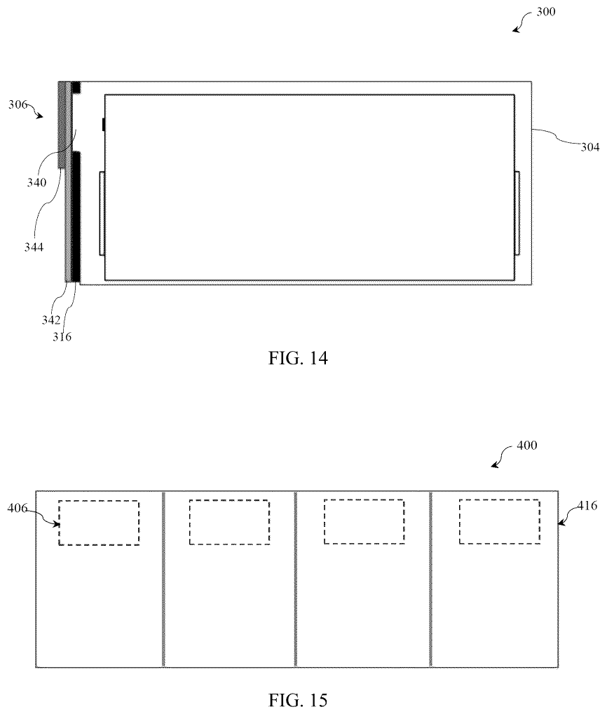

Referring to FIG. 14, a battery pack 300 according to yet another embodiment of the present disclosure is schematically shown. For brevity, only some features of the battery pack 300 are described below. Where compatible, other features can be referenced from the foregoing description regarding the battery pack 100. The battery pack 300 includes a first compartment 304. The first compartment 304 includes a first side wall 316 and a first element 306 thereon. A first opening 340 is provided on the first side wall 316. The first element 306 includes a first flexible thermal insulation layer 342 and a second flexible thermal insulation layer 344. The first flexible thermal insulation layer 342 covers the first opening 340. The second flexible thermal insulation layer 344 is connected to the first flexible thermal insulation layer 342 and is aligned with the first opening 340. The first flexible thermal insulation layer 342 is located between the second flexible thermal insulation layer 344 and the first side wall 316. The bonding strength between the first flexible thermal insulation layer 342 and the first side wall 316 is lower than the bonding strength between the first flexible thermal insulation layer 342 and the second flexible thermal insulation layer 344. The aforementioned bonding can be achieved by, but not limited to, means such as adhesion, welding, hot pressing, etc. The difference in bonding strength can be achieved, for example, through different bonding means (e.g., one by adhesion, the other by hot pressing), different adhesives (e.g., different adhesive chemistries), different bonding surface treatments (e.g., smooth or rough), and so on. Providing a lower bonding strength between the first flexible thermal insulation layer 342 and the first side wall 316 allows gas inside the first compartment 304 to more easily push the first flexible thermal insulation layer 342 to detach from the first side wall 316 for gas discharge when the internal pressure of the first compartment 304 exceeds the external pressure by a first internal pressure threshold. Before the external pressure outside the first compartment 304 exceeds the internal pressure by a second external pressure threshold, due to the higher bonding strength between the first flexible thermal insulation layer 342 and the second flexible thermal insulation layer 344, the external pressure pushes the second flexible thermal insulation layer 344 and the first flexible thermal insulation layer 342 to press tightly against the first side wall 316, keeping the interior of the first compartment 304 closed, thereby preventing or reducing the influence of pressure increases caused by other parts in the battery pack 300 on the interior of the first compartment 304.

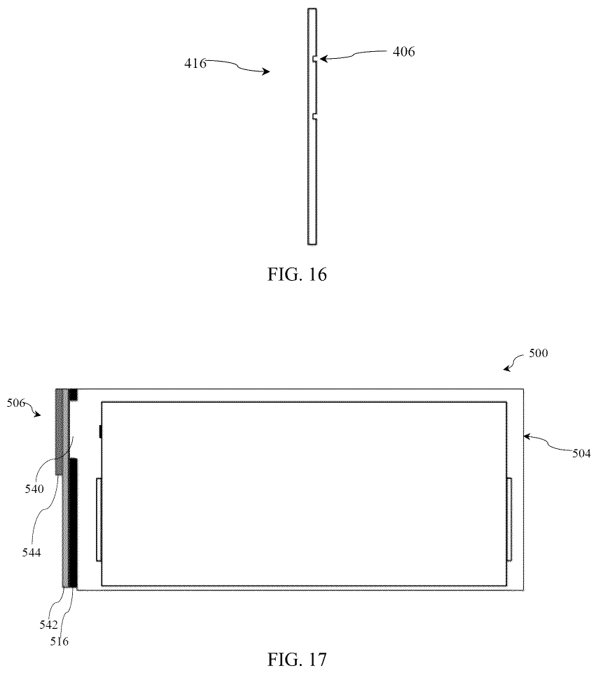

Referring to FIGS. 15 to 16, a battery pack 400 according to yet another embodiment of the present disclosure is schematically shown. For brevity, only some features of the battery pack 400 are described below. Where compatible, other features can be referenced from the foregoing description regarding the battery pack 100. The battery pack 400 includes a first compartment. The first compartment includes a first side wall 416 and a first element 406 thereon. The first element 406 comprises a groove that does not penetrate through the first side wall 416. The groove is provided on the inner side of the first side wall 416, shown as the right side in FIG. 16. In this configuration, providing the groove on the inner side of the first side wall 416 causes a difference in the rupture effect generated on the inner and outer sides of the first side wall 416 when facing the same pushing force. When the internal pressure exceeds the external pressure by a predetermined internal pressure threshold, stress focused at the groove of the first element 406 tears the first side wall 416, allowing gas inside the first compartment to escape. Furthermore, due to the absence of weakened structures such as a groove on the outer side of the first side wall 416, an equivalent pressure increase outside the first compartment cannot breach the first side wall 416. The first compartment can remain closed at least until the external pressure exceeds the internal pressure by an external pressure threshold, which is far greater than the internal pressure threshold.

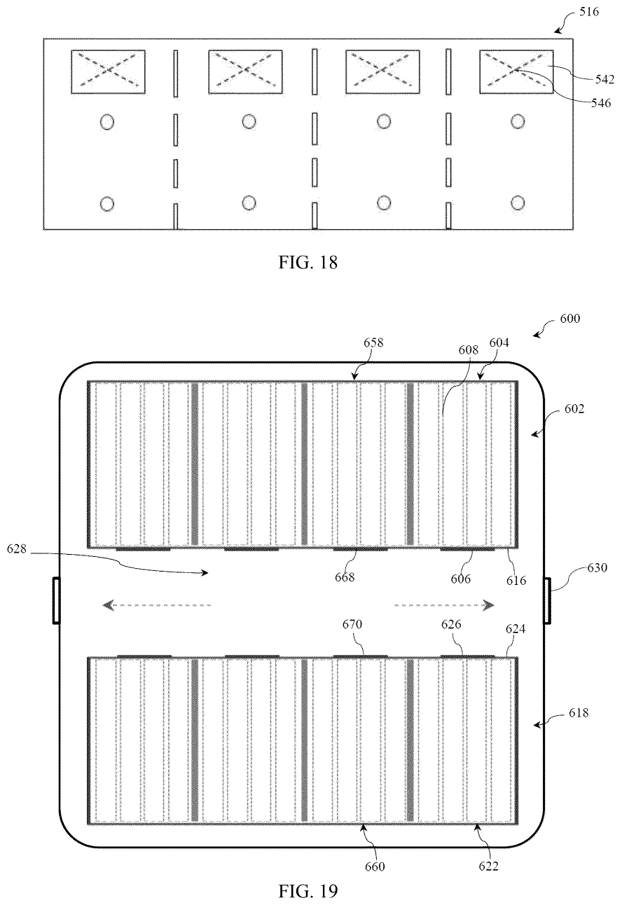

Referring to FIGS. 17 to 18, a battery pack 500 according to yet another embodiment of the present disclosure is schematically shown. For brevity, only some features of the battery pack 500 are described below. Where compatible, other features can be referenced from the foregoing description regarding the battery pack 100. The battery pack 500 includes a first compartment 504. The first compartment 504 includes a first side wall 516 and a first element 506 thereon. A first opening 540 is provided in the first side wall 516. The first element 506 includes a first flexible thermal insulation layer 542 and a second flexible thermal insulation layer 544. The first flexible thermal insulation layer 542 covers the first opening 540 and has a first weakened structure 546 opposite to the first opening 540, as shown in FIG. 18. The second flexible thermal insulation layer 544 is connected to the first flexible thermal insulation layer 542 and is aligned with the first opening 540, and the first flexible thermal insulation layer 542 is located between the second flexible thermal insulation layer 544 and the side wall 516. In this configuration, when the battery unit in the first compartment 504 discharges gas and the internal pressure exceeds the external pressure by a predetermined internal pressure threshold, the first weakened structure 546 ruptures and stress is focused on a small portion (such as a seam) of the outer second flexible thermal insulation layer 544 adjacent to the rupture, thereby further tearing the second flexible thermal insulation layer 544, allowing gas inside the first compartment 504 to escape. Due to the protection by the outer second flexible thermal insulation layer 544, an equivalent pressure increase outside the first compartment 504 cannot breach the second flexible thermal insulation layer 544 and the first flexible thermal insulation layer 542. The first compartment 504 can remain closed at least until the external pressure exceeds the internal pressure by an external pressure threshold, wherein the external pressure threshold is far greater than the internal pressure threshold.

Referring to FIG. 19, a battery pack 600 according to yet another embodiment of the present disclosure is schematically shown. For brevity, only some features of the battery pack 600 are described below. Where compatible, other features can be referenced from the foregoing description regarding the battery pack 100. The battery pack 600 has a first battery array 602. The first battery array 602 includes a first compartment 604 and a third compartment 658 that respectively accommodate several battery cells 608 and are adjacent to each other. The first compartment 604 and the third compartment 658 both include a first side wall 616 extending from the first compartment 604 to the third compartment 658. The first side wall 616 is located on the same facing side of the first compartment 604 and the third compartment 658 and is shared by both. The first compartment 604 and the third compartment 658 further include a first element 606 and a third element 668 disposed on the first side wall 616. The first element 606 and the third element 668 correspond to the first compartment 604 and the third compartment 658, respectively, and each has a first state in which it opens when the internal pressure of the first compartment 604 or the third compartment 658 exceeds the external pressure by a first threshold, and a second state in which it remains closed until the external pressure exceeds the internal pressure by a second threshold, wherein the first threshold is less than the second threshold. In this embodiment, based on the battery array structure, several compartments are provided, allowing the gas within each compartment to be discharged as needed, and to some extent, reducing the influence of pressure increase caused by the exhaust compartment within the battery pack 600 on the interior of the non-exhaust compartment. Simultaneously, sharing the first side wall 616 among several compartments and across the entire array simplifies the overall structure.

The battery pack 600 further includes a second battery array 618. The second battery array 618 includes a second compartment 622 and a fourth compartment 660 that respectively accommodate several battery cells 608 and are adjacent to each other. The second compartment 622 and the fourth compartment 660 include a second side wall 624 extending from the second compartment 622 to the fourth compartment 660, and a second element 626 and a fourth element 670 disposed on the second side wall 624. The second element 626 and the fourth element 670 correspond to the second compartment 622 and the fourth compartment 660, respectively. Each of the second element 626 and the fourth element 670 has a first state in which it opens when the internal pressure of the second compartment 622 or the fourth compartment 660 exceeds the external pressure by a third threshold, and a second state in which it remains closed until the external pressure exceeds the internal pressure by a fourth threshold, wherein the third threshold is less than the fourth threshold. The first side wall 616 and the second side wall 624 are arranged opposite to each other, and an exhaust channel 628 is formed between them. The exhaust channel 628 is in fluid communication with an exhaust valve 630. In this arrangement, the first side wall 616 of the first battery array 602 and the second side wall 624 of the second battery array 618 are positioned opposite to each other and share the exhaust channel 628. This makes the overall structure compact. Through the respective first element 606 and third element 668, and the second element 626 and fourth element 670, gas within the corresponding compartment can be discharged through the exhaust channel 628 as needed, and the influence of pressure increase outside the compartment caused by the exhaust gas from the compartment on the non-exhaust compartment on the opposite side is reduced to some extent.

In conclusion, compared with the prior art, the present disclosure proposes a battery pack. The technical solution of the present disclosure, relative to the prior art, can provide adaptive isolation measures for battery units under different working conditions, while allowing the discharging of gas, and can at least to some extent reduce the influence of the exhaust gas from the battery unit on other battery units inside the battery pack.

It should be understood that, on the premise of technical feasibility, the technical features listed above for different embodiments can be combined with each other to form other embodiments within the scope of the present disclosure.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-mentioned embodiments are possible examples of implementations of the present disclosure and are given only for the purpose of enabling those skilled in the art to clearly understand the principles of the present invention. It should be understood by those skilled in the art that the above discussion to any embodiment is only illustrative, and is not intended to imply that the disclosed scope of the embodiments of the present disclosure (including claims) is limited to these examples; and under the overall concept of the present invention, the technical features in the above embodiments or different embodiments can be combined with each other to produce many other changes in different aspects of embodiments of the present invention that is not provided in detailed description for the sake of brevity. Therefore, any omission, modification, equivalent replacement, improvement, etc. made within the spirit and principle of the embodiment of the present invention shall be included in the scope of protection claimed by the present invention.

What is claimed is:

1. A battery pack, comprising:
a battery unit; and
a first compartment for accommodating the battery unit, the first compartment comprising a first side wall having a first opening, a first flexible thermal insulation layer covering the first opening and including a first weakened structure opposite to the first opening, and a second flexible thermal insulation layer connected to the first flexible thermal insulation layer and aligned with the first opening.

2. The battery pack as recited in claim 1, wherein the first flexible thermal insulation layer is located between the second flexible thermal insulation layer and the first side wall.

3. The battery pack as recited in claim 1, comprising a second compartment that includes a second side wall having a second opening, a third flexible thermal insulation layer covering the second opening and including a second weakened structure opposite to the second opening, and a fourth flexible thermal insulation layer connected to the third flexible thermal insulation layer and aligned with the second opening.

4. The battery pack as recited in claim 3, wherein the first side wall is arranged opposite to the second side wall, and comprising an exhaust channel that extends between the first side wall and the second side wall.

5. The battery pack as recited in claim 4, comprising an exhaust valve that is in fluid communication with the exhaust channel.

6. The battery pack as recited in claim 3, comprising a third compartment adjacent to the first compartment, and a fourth compartment adjacent to the second compartment, wherein a first thermal insulation plate is located between the first compartment and the third compartment, and a second thermal insulation plate is located between the second compartment and the fourth compartment.

7. The battery pack as recited in claim 1, wherein the first side wall includes a second weakened structure.

8. The battery pack as recited in claim 7, wherein the first weakened structure is configured to rupture when an internal pressure of the first compartment exceeds an external pressure by a first threshold, the second weakened structure is configured to rupture when the internal pressure of the first compartment exceeds the external pressure by a second threshold, and the second threshold is greater than the first threshold.

9. The battery pack as recited in claim 7, wherein the second weakened structure includes a discontinuous cut seam or groove provided in the first side wall, and the discontinuous cut seam or groove defines at least a portion of a boundary of the first side wall.

10. The battery pack as recited in claim 1, wherein the battery unit includes an exhaust port facing the first side wall.

11. The battery pack as recited in claim 1, wherein the first side wall comprises a thermal isolation material.

12. The battery pack as recited in claim 1, wherein the first flexible thermal insulation layer includes a first thickness, and the second flexible thermal insulation layer includes a second thickness greater than the first thickness.

13. A battery pack, comprising:
a battery unit; and
a first compartment configured for accommodating the battery unit, the first compartment including a first side wall and a first element disposed on the first side wall,
wherein the first element has (1) a first state in which the first element opens when an internal pressure of the first compartment exceeds an external pressure by a first threshold, and (2) a second state in which the first element remains closed until the external pressure exceeds the internal pressure by a second threshold.

14. The battery pack as recited in claim 13, wherein the first threshold is less than the second threshold.

15. The battery pack as recited in claim 13, comprising a second compartment configured for accommodating a second battery unit, and the second compartment includes a second side wall and a second element disposed on the second side wall, wherein the second element has (1) a first state in which the second element opens when an internal pressure of the second compartment exceeds an external pressure by a third threshold, and (2) a second state in which the second element remains closed until the external pressure exceeds the internal pressure by a fourth threshold.

16. The battery pack as recited in claim 15, wherein the third threshold is less than the fourth threshold.

17. The battery pack as recited in claim 15, wherein the first side wall is arranged opposite to the second side wall, and an exhaust channel extends between the first side wall and the second side wall.

18. The battery pack as recited in claim 13, wherein the first side wall includes a first opening, and the first element includes a first thermal insulation layer covering the first opening from an exterior of the first compartment.

19. The battery pack as recited in claim 18, wherein the first thermal insulation layer comprises a flexible thermal isolation material.

20. The battery pack as recited in claim 13, wherein the first side wall includes a first opening, and the first element comprises:
a first flexible thermal insulation layer covering the first opening, wherein the first flexible thermal insulation layer has a first weakened structure opposite to the first opening; and
a second flexible thermal insulation layer connected to the first flexible thermal insulation layer and aligned with the first opening;
wherein the first flexible thermal insulation layer is located between the second flexible thermal insulation layer and the first side wall.
